(19) United States
(12) Patent Application Publication
(10) Pub. No.: US 2009/0232053 A1
(43) Pub. Date: Sep. 17, 2009

(54) WIRELESS COMMUNICATION APPARATUS HAVING ACKNOWLEDGEMENT FUNCTION AND WIRELESS COMMUNICATION METHOD

(76) Inventors: Daisuke TAKI, Yokohama-shi (JP); Masahiro Sekiya, Inagi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/402,683

(22) Filed: Mar. 12, 2009

(30) Foreign Application Priority Data
Mar. 13, 2008 (JP) 2008-064232

(51) Int. Cl. H04W 84/02

(52) U.S. Cl. 370/328

(57) ABSTRACT

A wireless communication apparatus includes a reception unit, an information management unit, and a transmission unit. The reception unit receives data including a plurality of data frames. The data frames are transmitted from an identical data source and managed by an identical traffic identifier. The information management unit retains acknowledgement information to perform an acknowledgement. The information management unit discards an already-retaining acknowledgement information when the data is newly received. The transmission unit performs the acknowledgement to the data source of the data using the acknowledgement information. The transmission unit performs the acknowledgement to the data corresponding to the acknowledgement information irrespective of a request of the acknowledgement from the data source when the information management unit discards the acknowledgement information or when a prediction on the discard of the acknowledgement information is made.

### CROSS-REFERENCE TO RELATED APPLICATIONS

This application is based upon and claims the benefit of priority from prior Japanese Patent Application No. 2008-064232, filed Mar. 13, 2008, the entire contents of which are incorporated herein by reference.

### BACKGROUND OF THE INVENTION

1. Field of the Invention

The present invention relates to a wireless communication apparatus and a wireless communication method, for example, relates to a wireless communication apparatus which can collectively perform acknowledgement of plural frames.

2. Description of the Related Art

Currently the Institute of Electrical and Electronics Engineers (IEEE) 802.11n standard which is of a high-speed wireless local area network (LAN) standard for a next generation is being drawn up by the IEEE 802.11 committee.

A partial state Block Acknowledgement (partial state BA) function, in which the Block Acknowledgement function (hereinafter referred to as the Block Ack [BA] function) is simplified, is adopted in the IEEE 802.11n standard. In the partial state BA function, when plural pieces of data having different data sources or different traffic identifiers are received, a management region is emptied out by discarding acknowledgement information on another pieces of data retained until then in the management region, and acknowledgement information on new data is retained in the same management region. Accordingly, in the IEEE 802.11n standard, the same management region is used more than once, and whereby the block acknowledgement function can be realized by a management region of at least one piece of acknowledgement information.

For example, the following document discloses the BA function: “802.11e-2005 Standard for Information technology-Telecommunications and information exchange between systems-Local and metropolitan area networks-Specific requirements Part 11: Wireless LAN Medium Access Control (MAC) and Physical Layer (PHY) specifications, Amendment 8: Medium Access Control (MAC) Quality of Service Enhancements”, URL: http://ieeexplore.ieee.org/servlet/opac?punumber=10328. For example, the following document discloses the partial state BA function: “P802.11n/D3.00 Draft Standard for Information Technology-Telecommunications and information exchange between systems—Local and metropolitan area networks—Specific requirements—Part 11: Wireless LAN Medium Access Control (MAC) and Physical Layer (PHY) specifications: Amendment 4: Enhancements for Higher Throughput”, URL: http://ieeexplore.ieee.org/servlet/opac?punumber=436010 6.

### BRIEF SUMMARY OF THE INVENTION

A wireless communication apparatus according to an aspect of the present invention includes:

a reception unit which is capable of receiving data including a plurality of data frames, the data frames being transmitted from an identical data source and managed by an identical traffic identifier;

an information management unit which retains acknowledgement information to perform an acknowledgement in the each data received by the reception unit, the information management unit discarding an already-retaining acknowledgement information in order to retain acknowledgement information on data when the data is newly received from a data source different from a data source corresponding to the already-retaining acknowledgement information or when the data whose traffic identifier is different from a traffic identifier of the already-retaining acknowledgement information is newly received from the data source identical to the data source corresponding to the already-retaining acknowledgement information; and

a transmission unit which performs the acknowledgement to the data source of the data using the acknowledgement information, the transmission unit performing the acknowledgement to the data corresponding to the acknowledgement information irrespective of a request of the acknowledgement from the data source when the information management unit discards the acknowledgement information or when a prediction on the discard of the acknowledgement information is made.

A wireless communication method according to an aspect of the present invention includes:

receiving data including a plurality of data frames, the data frames being transmitted from an identical data source and managed by an identical traffic identifier;

discarding already-retaining acknowledgement information in order to retain acknowledgement information on the received data; and

transmitting a frame for acknowledgement using a Delayed BA frame with respect to the data corresponding to the acknowledgement information which becomes a discard target irrespective of a request of the acknowledgement from a data source.

### BRIEF DESCRIPTION OF THE SEVERAL VIEWS OF THE DRAWING

FIG. 1 is a block diagram showing a wireless communication system according to a first embodiment of the present invention;

FIG. 2 is a block diagram showing a wireless LAN base station of the first embodiment;

FIG. 3 is a schematic diagram showing a configuration of a data frame;

FIGS. 4 and 5 are timing charts showing concepts of Immediate BA and Delayed BA;

FIG. 6 is a block diagram showing a retention unit of the first embodiment;

FIG. 7 is a schematic diagram showing a configuration of A-MPDU;

FIG. 8 is a schematic diagram showing a concept of bitmap information;

FIG. 9 is a timing chart showing a state of data communication in the wireless communication system of the first embodiment;

FIG. 10 is a flowchart showing an operation of the wireless LAN base station of the first embodiment;

FIGS. 11 and 12 are block diagrams showing a reordering management unit and a BA management unit according to a second embodiment of the invention;

FIG. 13 is a flowchart showing an operation of a wireless communication apparatus of the second embodiment;

FIG. 14 is a block diagram showing a wireless LAN base station according to a third embodiment of the invention;

FIG. 15 is a band diagram showing a frequency band used in the wireless LAN base station of the third embodiment;

FIG. 16 is a timing chart showing a state of data communication in a wireless communication system of the third embodiment; and

FIGS. 17 and 18 are flowcharts showing operations of wireless LAN base stations according to third and fourth embodiments of the invention.

### DETAILED DESCRIPTION OF THE INVENTION

### First Embodiment

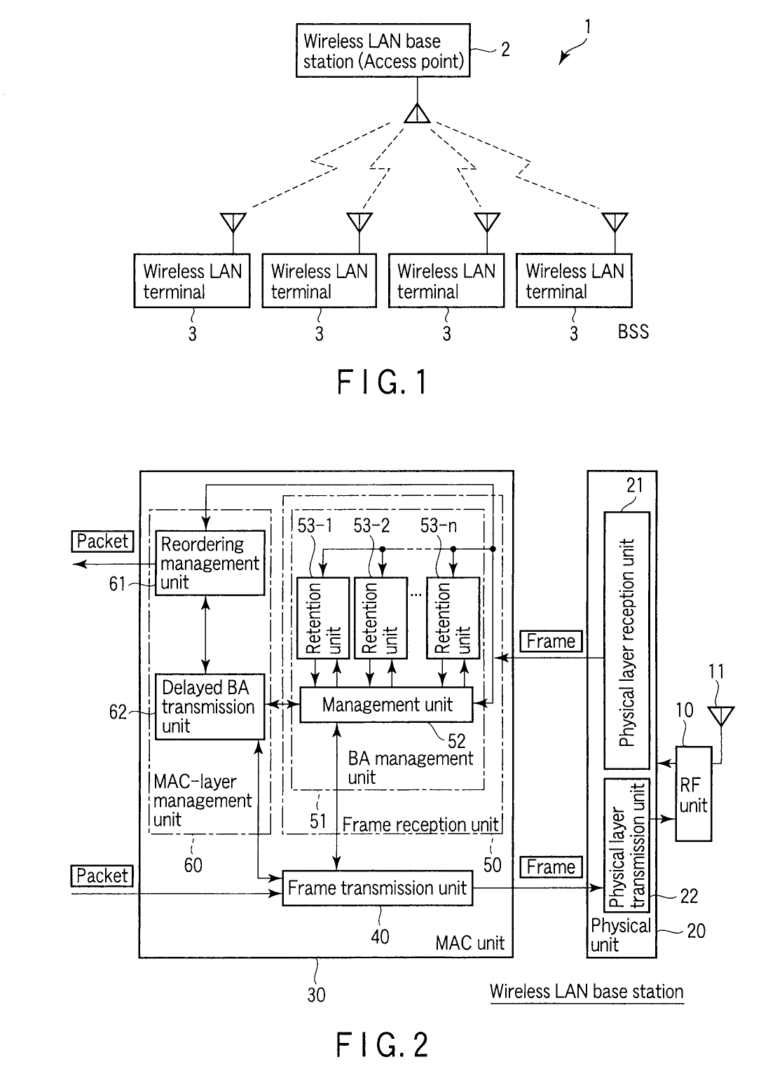

A wireless communication apparatus according to a first embodiment of the present invention will be described with reference to FIG. 1. FIG. 1 is a block diagram showing a wireless communication system according to the first embodiment.

### <Configuration of Wireless Communication System>

As shown in FIG. 1, a wireless communication system 1 includes a wireless LAN base station (access point) 2 and plural wireless LAN terminals (stations) 3, and the wireless LAN base station 2 and the plural wireless LAN terminals 3 form a communication network (LAN). The wireless LAN terminal 3 conducts wireless communication with the wireless LAN base station 2. The wireless LAN base station 2 accommodates the wireless LAN terminal 3 therein to form a Basic Service Set (BSS). The wireless LAN base station 2 is connected to a server (not shown) through, for example, a cable LAN, or to the Internet through a metal line, an optical fiber or the like by an internet service provider.

### <Configuration of Wireless LAN Base Station 2>

A configuration of the wireless LAN base station 2 will be described with reference to FIG. 2. FIG. 2 is a block diagram of the wireless LAN base station 2. The wireless LAN terminal 3 has also the same configuration as the wireless LAN base station 2.

Referring to FIG. 2, the wireless LAN base station 2 mainly includes a radio-frequency (RF) unit 10, a physical unit 20, and a Media Access Control (MAC) unit 30. The RF unit 10 amplifies analog data which is received and transmitted through the wireless communication or the like, and transmits or receives the analog data through an antenna 11. The physical unit 20 and the MAC unit 30 receive data (hereinafter referred to as transmission data) which is downloaded from a server or the Internet and should be transmitted to the wireless LAN terminal 3 from an interface unit (not shown), perform signal processing to the data, and supply the data to the RF unit 10. The physical unit 20 and the MAC unit 30 also perform signal processing to data received from the wireless LAN terminal 3, and supply the data to the interface unit.

In transmission data and reception data, hereinafter the transmission data and reception data on the side of the wireless LAN terminal 3 from the MAC unit 30 are referred to as “frame”, and the transmission data and reception data on the interface side are referred to as “packet”. The packet means transmission data and reception data which are constructed into a data structure dealt with by a personal computer and the like. The frame means transmission data and reception data which are constructed so as to be able to be communicated through the wireless communication. Hereinafter the net frame which should be transmitted and received is referred to as data frame. The data frame mainly includes a MAC header and a frame body which is of the net data.

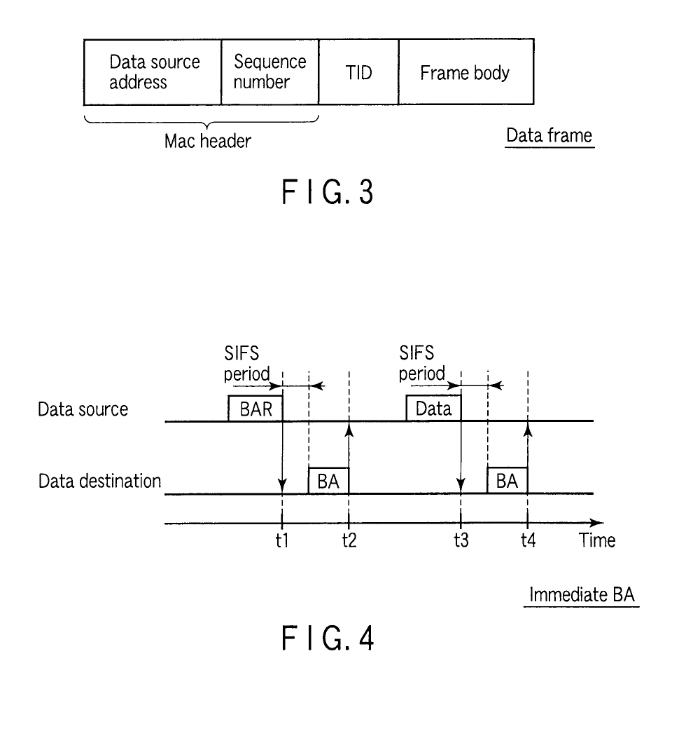

FIG. 3 is a schematic diagram showing a configuration of one data frame. Referring to FIG. 3, the data frame includes the MAC header and the frame body. The frame body indicates contents of the net data. The MAC header includes a data source address, a sequence number, and a traffic ID (TID). The traffic ID means an identifier which manages the data. The data frame is accompanied by a frame number having a value of 0 to 4095, and the frame number is referred to as sequence number. That is, the wireless LAN base station 2 can grasp the data source address, the sequence number, and the traffic ID from the MAC header of the data. However, because the wireless LAN base station 2 gives a transmission right to the wireless LAN terminal 3, the wireless LAN base station 2 can grasp the data transmitted from which wireless LAN terminal 3 at the time the data is received.

The transmission data may be transmitted while plural data frames are collected. In such cases, the plural collectively-transmitted data frames are managed by the same traffic ID. The data frames may be transmitted while aggregated, or the data frames may separately be transmitted at time intervals. The aggregated plural data frames have the same traffic ID, but the data frames have the different sequence numbers.

The physical unit 20 and the MAC unit 30 in the wireless LAN base station 2 will be described in detail.

### <Configuration of Physical Unit 20>

First a configuration of the physical unit 20 will be described. The physical unit 20 includes a physical layer reception unit 21 and a physical layer transmission unit 22. The physical layer reception unit 21 and the physical layer transmission unit 22 perform transmission and reception processing to a physical layer of the frame which should be transmitted and received. Specifically, the physical layer transmission unit 22 receives a transmission frame and a transmission rate of the transmission frame, performs redundant coding to the transmission frame, and then performs orthogonal frequency division multiplexing (OFDM) modulation to obtain a baseband transmission signal. The physical layer transmission unit 22 further performs digital-to-analog conversion of the baseband transmission signal to obtain an analog signal. The physical layer reception unit 21 performs inverse processing to the reception frame. That is, the physical layer reception unit 21 performs analog-to-digital conversion of the received analog signal, and then performs OFDM demodulation and error correction decoding to obtain a frame. Hereinafter the frame obtained by the physical layer reception unit 21 is referred to as MPDU (MAC Protocol Data Unit).

### <Configuration of MAC Unit 30>

Next the MAC unit 30 will be described. The MAC unit 30 mainly includes a frame transmission unit 40, a frame reception unit 50, and a MAC-layer management unit 60.

### <Frame Transmission Unit 40>

The frame transmission unit 40 constructs the frame by adding the MAC header to the packet which is received from higher-level layer of a MAC-layer (for example, a personal computer) through the interface unit (not shown), and supplies the frame to the physical layer transmission unit 22. That is, the frame transmission unit 40 has a function of transmitting a single piece of data as the data frame (MPDU) or transmitting an Aggregated-MPDU (A-MPDU) in which plural MPDUs are coupled. In addition to the data frame, the frame transmission unit 40 produces and transmits a management frame and a control frame which are necessary for protocol processing of the MAC layer in response to a command of the frame reception unit 50 or the MAC-layer management unit 60.

Examples of the management frame include, for example, a beacon frame and a Set PCO Phase frame. These frames are described later in a third embodiment.

Examples of the control frame include a response frame (hereinafter referred to as an Acknowledge [ACK] frame) to an MPDU and a response frame (hereinafter referred to as a Block ACK [BA] frame) to an A-MPDU or a Block ACK Request (BAR) frame.

The response frame is used to inform the transmission side whether or not a frame is correctly received by the reception side when the frame is transmitted and received between the wireless LAN base station 2 and the wireless LAN terminal 3. For example, when the wireless LAN base station 2 transmits the frame, one of the wireless LAN terminals 3 which becomes a destination transmits the response frame to the wireless LAN base station 2. Therefore, the wireless LAN base station 2 can recognize whether or not the frame is correctly transmitted, and transmits the frame again if the frame is not correctly transmitted.

The BA frame in the response frame is used as a frame for the block acknowledgement. In the block acknowledgement, the acknowledgement is performed to data using one BA frame, the data including plural data frames and being managed by the same traffic ID. The BAR frame is used in order that the frame transmission side obtains the BA frame to the destination.

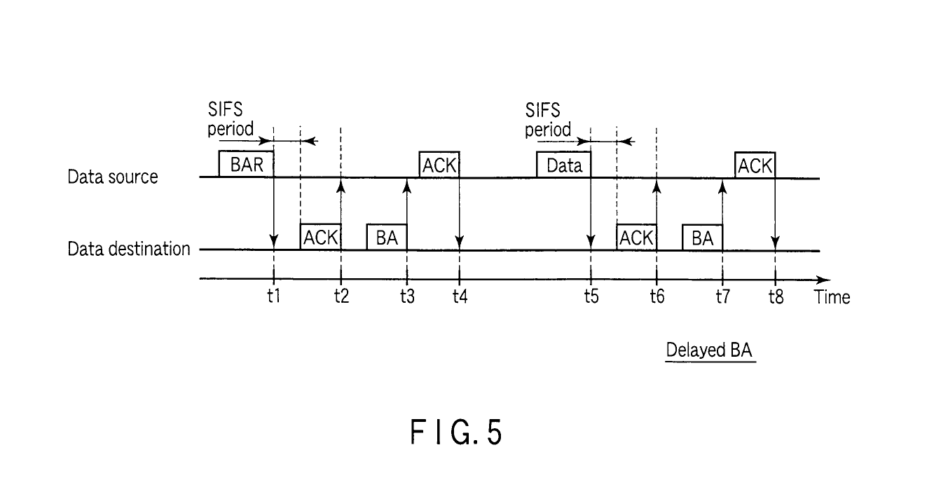

The BA frame classified into two kinds of frames, that is, an Immediate BA frame and a Delayed BA frame. The Immediate BA frame will be described with reference to FIG. 4. FIG. 4 is a timing chart showing a frame sequence between the data source and the destination.

In response to the reception of the BAR frame, the Immediate BA frame is transmitted to a data source immediately after a given short interframe space (SIFS) period. The SIFS period means a period during which no frame is transmitted. As shown in FIG. 4, when the BA frame is received at a time t1, the transmission of the BA frame is started after the SIFS period elapses from time t1, and the transmission of the BA frame is ended at a time t2.

The BAR frame is not limited to the case in which the transmission is explicitly performed like the times t1 and t2 of FIG. 4. The BAR frame may be transmitted in the cases where an acknowledgement request is implicitly received using an Implicit block acknowledgement request function newly defined in the IEEE 802.11n. The Implicit block acknowledgement request function means a function which can make a BA frame request without transmitting the BAR frame by adding predetermined information to the MAC header of the data frame. Therefore, the data reception side can consider that the BA frame response request by the Implicit block acknowledgement request function is similar to the BA frame response request by the BAR frame. In such cases, as shown in FIG. 4, when the data frame is received at a time t3, the transmission of the BA frame is started after the SIFS period elapses from time t3, and the transmission of the BA frame is ended at a time t4.

The Delayed BA frame will be described. When the BAR frame is received, the Delayed BA frame is transmitted after an arbitrary period elapses. Because usually the arbitrary period is longer than the SIFS period, the data source can produce the BAR frame with lead time longer than that of the use of the Immediate BA frame.

In the case of the use of the Delayed BA frame, in response to the reception of the BAR frame, the ACK frame is tentatively transmitted to the data source immediately after the SIFS period. Then the BA frame is transmitted after an arbitrary period elapses. The Delayed BA frame is usually transmitted as the frame in which the response is expected. Accordingly, because the data source which received the Delayed BA frame sends back the ACK frame in response to the Delayed BA frame, the Delayed BA frame has an advantage that the BA frame can more correctly be transmitted to the other party compared with the Immediate BA frame having no acknowledgement response.

FIG. 5 is a timing chart showing a frame sequence in cases where the Delayed BA frame is used. Referring to FIG. 5, when the BAR frame is received at time t1, the transmission of the ACK frame is started immediately after the SIFS period elapses from time t1, and the transmission of the ACK frame is completed at time t2. Then, after an arbitrary period elapses, the BA frame is transmitted at time t3, and the ACK frame for the BA frame is transmitted at time t4. The same holds true for the case in which the Implicit block acknowledgement request function is used, and the case in which the Implicit block acknowledgement request function is used is shown at times t5 to t8.

The Immediate BA frame and the Delayed BA frame differ from each other only in transmission timing, and the Immediate BA frame and the Delayed BA frame are identical to each other in a frame format.

### <Frame Reception Unit 50>

Referring to FIG. 2, the frame reception unit 50 in the MAC unit 30 will be described. The frame reception unit 50 includes a block acknowledgement management unit (BA management unit) 51.

The BA management unit 51 includes a management unit 52 and n retention units 53-1 to 53-n (n is a natural number). Hereinafter, the retention units 53-1 to 53-n are collectively referred to as retention unit 53 when the units 53-1 to 53-n are not being distinguished from one another. The same holds true in the case of n=1.

The retention unit 53 retains acknowledgement information on the received data (MPDU or A-MPDU). As described above, the acknowledgement information indicates that the data frame can correctly be received or that the data frame cannot correctly be received.

When receiving the data (MPDU or A-MPDU) from the physical layer reception unit 21, the management unit 52 determines which retention unit 53 retains the acknowledgement information on the frame, and manages the data source (which wireless LAN terminal 3) or traffic ID for the acknowledgement information retained by each retention unit 53. The management unit 52 instructs the retention unit 53 to discard and overwrite the retained acknowledgement information if needed. That is, the pieces of acknowledgement information on the n-pieces of data can be retained when the n retention units 53 are provided. However, when a new frame is further received, it is necessary that one of the retention units 53 be opened by discarding the acknowledgement information retained until then. Therefore, the management unit 52 issues a command for discarding the acknowledgement information to one of the retention units 53 in such the case. That is, the old acknowledgement information retained until then is overwritten by new acknowledgement information.

When the management unit 52 receives the BAR frame from the physical layer reception unit 21, or receives the data frame in which the Implicit block acknowledgement request function is used, the management unit 52 instructs the frame transmission unit 40 to transmit the Immediate BA frame. At this point, the corresponding acknowledgement information is supplied from one of the retention units 53 to the frame transmission unit 40. The frame transmission unit 40 transmits the Immediate BA frame based on the command and the corresponding acknowledgement information.

When the data is newly received while all the retention units 53 are filled with the acknowledgement information, it is necessary to discard the acknowledgement information retained in one of the retention units 53. In such cases, the management unit 52 issues a command for transmitting the Delayed BA frame to the MAC-layer management unit 60. At this point, after the acknowledgement information to be discarded is tentatively retained in a save region (not shown), the management unit 52 supplies the acknowledgement information to the MAC-layer management unit 60.

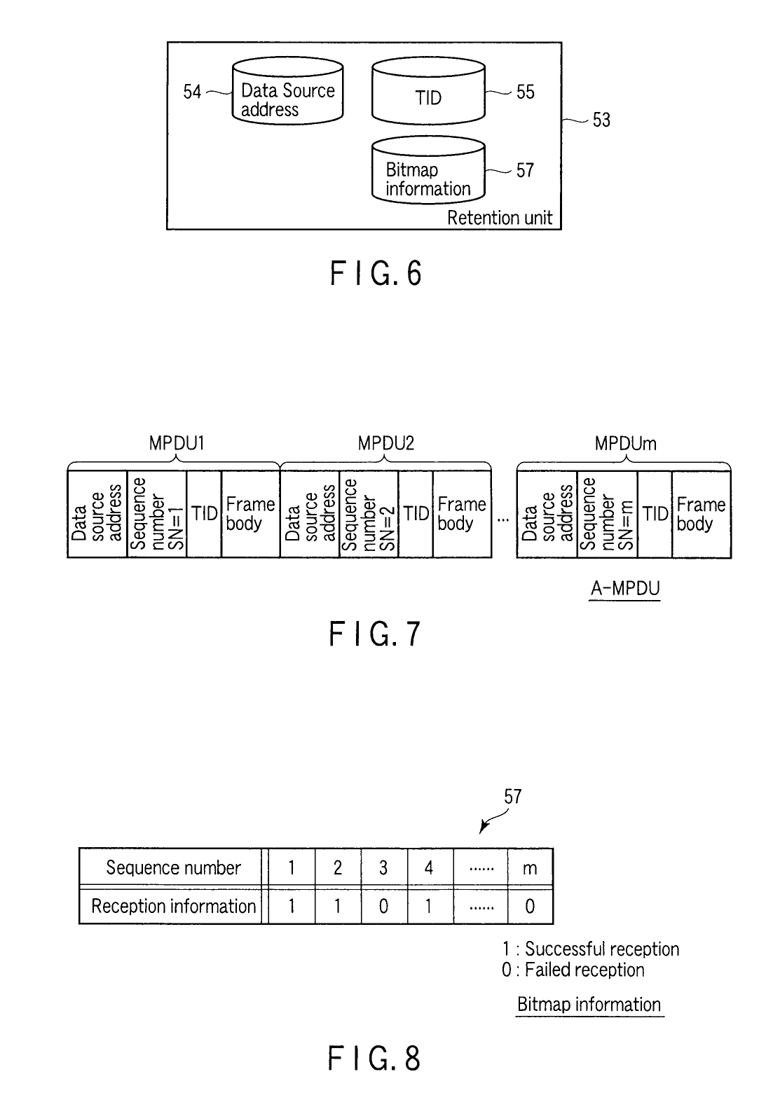

The acknowledgement information possessed by the retention unit 53 will be described with reference to FIG. 6. FIG. 6 is a block diagram showing the retention unit 53, particularly showing the data which is retained as the acknowledgement information.

As shown in FIG. 6, the retention unit 53 retains a data source address 54, a traffic ID 55, and bitmap information 57 as the acknowledgement information. Obviously the acknowledgement information retained by one retention unit 53 is transmitted from one of the wireless LAN terminals 3, and is information on data managed by a traffic ID.

As described above, the source address 54 is information which indicates the wireless LAN terminal 3 which transmitted the data. That is, each address is allocated to each wireless LAN terminal 3 in BSS formed by the wireless LAN base station 2. The allocated address is the source address 54, and the determination which wireless LAN terminal 3 transmits the data can be made by the source address 54.

As described above, the traffic ID 55 is the identifier which manages the plural data frames collectively transmitted from a certain wireless LAN terminal 3. That is, in cases where the plural pieces of data are transmitted from the same wireless LAN terminal 3, each piece of data can be determined by the traffic ID 55.

The bitmap information 57 is information which indicates whether or not the wireless LAN base station 2 normally received the plural data frames included in one piece of data. A specific example of the bitmap information 57 will be described below. The bitmap information 57 is expressed by data of “0” or “1” corresponding to a sequence number SN of each data frame. The bit of “1” indicates that the data frame having the sequence number SN corresponding to the bit position has been successfully received, and the bit of “0” indicates that the data frame having the sequence number SN corresponding to the bit position has not been correctly received. The bitmap information 57 is added to the BA frame, and transmitted to the wireless LAN terminal 3 which is of the data source. The wireless LAN terminal 3 which is of the data source can grasp that the data frame having the sequence number SN corresponding to the bit of “1” has been correctly transmitted, and transmits again the data frame in which the bit of “0” is set.

FIGS. 7 and 8 are conceptual views showing the data and the bitmap information 57, respectively. As shown in FIG. 7, it is assumed that the data which is transmitted from a certain wireless LAN terminal 3 and managed by one traffic ID includes m (m is a natural number of 1 or more) data frames, and that the sequence number accompanying each of the data frames ranges from “1” to “m”. An example of the bitmap information 57 in this case is shown in FIG. 8.

As shown, the bitmap information 57 includes the sequence number SN and reception information corresponding to the sequence number SN. In the example of FIG. 8, the reception of the data frames of SN=“1”, “2”, and “4” is succeed, and the reception of the data frames of SN=“3” and “m” is failed.

The frame reception unit 50 includes the BA management unit 51. When receiving the data from the physical layer reception unit 21, the frame reception unit 50 removes the MAC header from the frame to construct the packet, and supplies the packet to the MAC-layer management unit 60 in the order of the sequence number SN.

### <MAC-Layer Management Unit 60>

Referring to FIG. 2, a configuration of the MAC-layer management unit 60 will be described below. The MAC-layer management unit 60 performs the transmission and reception of a management frame necessary for the protocol processing in the MAC layer, protocol management, and the transmission and reception of a control frame. The MAC-layer management unit 60 further includes a reordering management unit 61 and a Delayed BA management unit 62.

The reordering management unit 61 receives the packet from the frame reception unit 50. In cases where the data includes the aggregated plural data frames, the order of the data frame transmission is not always limited to the order of the sequence number SN. Therefore, the reordering management unit 61 reorders the received packets in the order of the sequence number SN, and then supplies the reordered packets from an interface unit (not shown) to a higher-level layer.

In response to the command from the management unit 52 in the BA management unit 51, the Delayed BA transmission unit 62 constructs the Delayed BA frame using the received acknowledgement information. The Delayed BA transmission unit 62 transmits the constructed Delayed BA frame to the wireless LAN terminal 3 through the frame transmission unit 40.

### <Operation of Wireless Communication System 1>

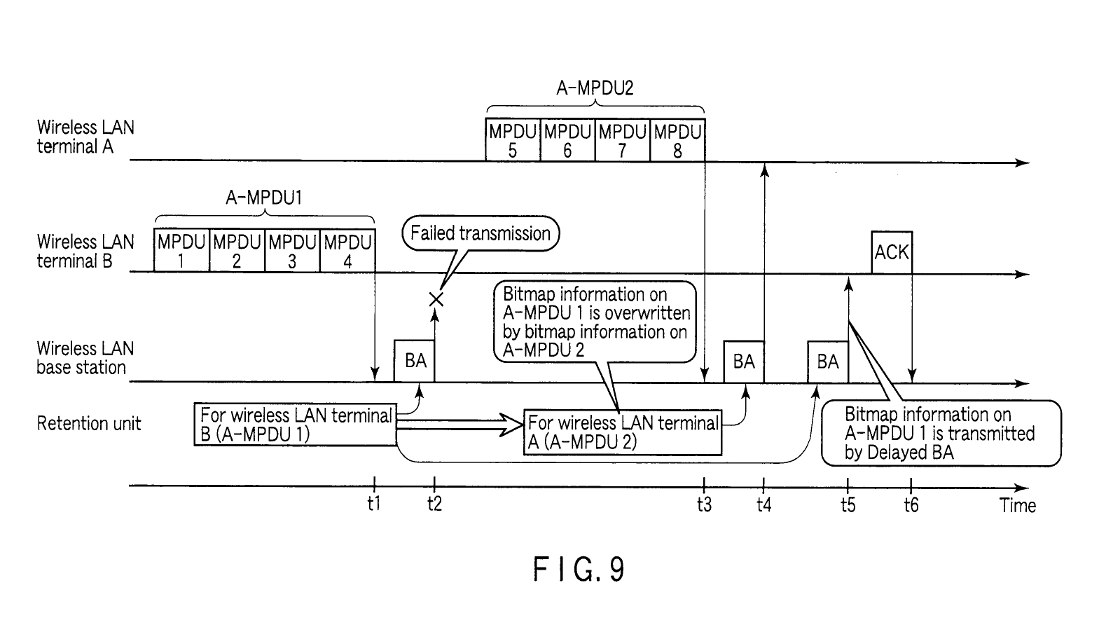

A block acknowledgement operation of the wireless LAN base station 2 in the wireless communication system having the above-described configuration will be described with reference to FIG. 9. FIG. 9 is a timing chart showing operations of the wireless LAN terminal 3 and wireless LAN base station 2 and a state of the retention unit 53. In FIG. 9, a horizontal axis indicates time. For the sake of convenience of explanation, two wireless LAN terminals 3 are provided, the terminals being referred to as wireless LAN terminals A and B respectively, and one retention unit 53 is provided.

Referring to FIG. 9, the wireless LAN base station 2 receives the data transmitted from wireless LAN terminal B at time t1. The data received at time t1 is A-MPDU 1 including MPDU 1 to MPDU 4 which are aggregated.

In the wireless LAN base station 2, the retention unit 53 retains the bitmap information on A-MPDU 1. In response to the command of the management unit 52, the frame transmission unit 40 produces the Immediate BA frame to which the bitmap information on A-MPDU 1 is added, and transmits the Immediate BA frame to wireless LAN terminal B at time t2.

However, it is assumed that the transmission of the BA frame transmitted at time t2 is failed in the wireless LAN terminal B. In FIG. 9, the mark “x” indicates the failed transmission.

After that, the wireless LAN terminal A transmits A-MPDU 2 to the wireless LAN base station 2 before wireless LAN terminal B receives the BA frame. A-MPDU 2 includes MPDU 5 to MPDU 8 which are aggregated, and the wireless LAN base station 2 receives A-MPDU 2 at time t3.

Because of the need to produce and retain the acknowledgement information on A-MPDU 2, the wireless LAN base station 2 which received A-MPDU 2 causes the retention unit 53 to discard the acknowledgement information on A-MPDU 1 transmitted from wireless LAN terminal B. The wireless LAN base station 2 then makes the retention unit 53 retain the acknowledgement information on A-MPDU 2.

The wireless LAN base station 2 produces the Immediate BA frame to which the acknowledgement information on A-MPDU 2 is added, and transmits the Immediate BA frame to wireless LAN terminal A at time t4. At this point, in the wireless LAN base station 2, the Delayed BA transmission unit 62 produces the Delayed BA frame to which the bitmap information on A-MPDU 1 is added. The produced Delayed BA frame is transmitted to wireless LAN terminal B at time t5.

When wireless LAN terminal B normally receives the Delayed BA frame, wireless LAN terminal B transmits the ACK frame corresponding to the received Delayed BA frame to the wireless LAN base station 2.

In the example of FIG. 9, the wireless LAN terminal 2 can retain only one piece of acknowledgement information. However, the embodiment is not limited to the one piece of acknowledgement information, and plural pieces of acknowledgement information may be retained. In such cases, the operation similar to that of FIG. 9 is performed when the number of received data streams is larger than the number of pieces of acknowledgement information which can be retained in the wireless LAN terminal 2.

### <Operation of Wireless LAN Base Station 2>

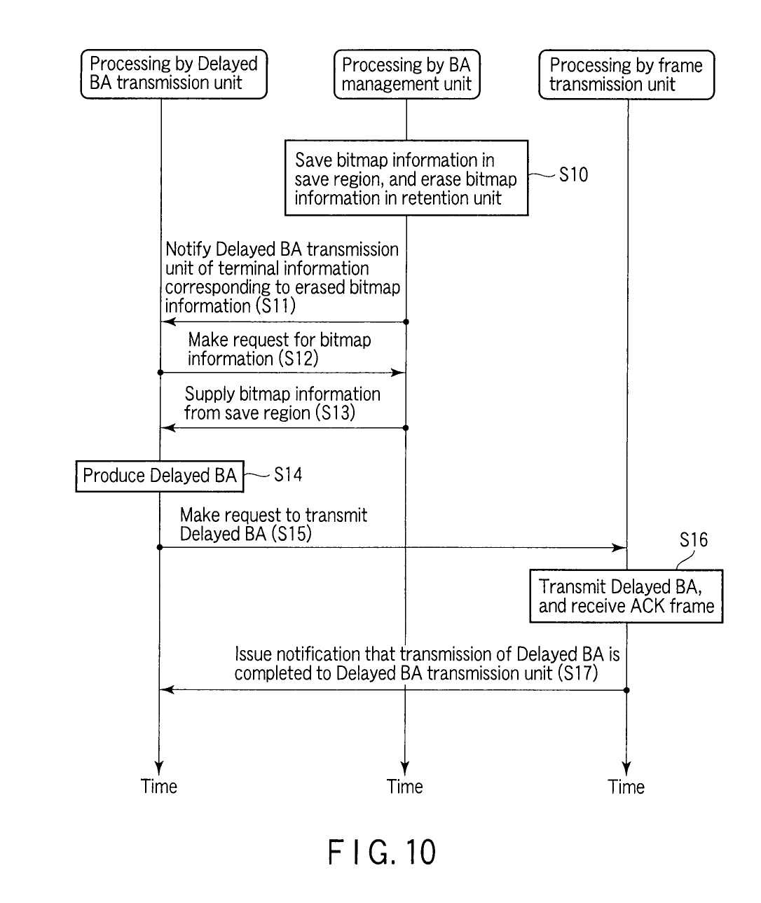

The detailed operation of the wireless LAN base station 2 of FIG. 9 will be described with reference to FIG. 10. FIG. 10 is a flowchart showing the operation of the wireless LAN base station 2 of the first embodiment, particularly showing processing performed by the frame transmission unit 40, the BA management unit 51, and the Delayed BA transmission unit 62.

As shown in FIG. 10, the BA management unit 51 detects that an event in which the acknowledgement information retained in the retention unit 53 is erased. Specifically, in FIG. 9, the event is occurred at the time the wireless LAN base station 2 receives A-MPDU 2. The management unit 52 in the BA management unit 51 then causes the retention unit 53 to save the acknowledgement information including the bitmap information in the save region, and erases the acknowledgement information in the retention unit 53 (Step S10). The erased acknowledgement information is the information on A-MPDU 1 of FIG. 9.

The management unit 52 notifies the Delayed BA transmission unit 62 of the information on a wireless LAN terminal (wireless LAN terminal B in FIG. 9) corresponding to the erased bitmap information (Step S11). The notified information includes the data source address (MAC address) for specifying the wireless LAN terminal and the traffic ID.

The Delayed BA transmission unit 62 which is notified of the erasure of the acknowledgement information then makes a request of the bitmap information on wireless LAN terminal B whose acknowledgement information is erased to the management unit 52 (Step S12).

In response to the request in Step S12, the management unit 52 supplies the bitmap information on A-MPDU 1 saved in the save region to the Delayed BA transmission unit 62 (Step S13).

The Delayed BA transmission unit 62 which receives the bitmap information in Step S13 produces the Delayed BA frame based on the received bitmap information (Step S14). The Delayed BA transmission unit 62 then transfers the produced Delayed BA frame to the frame transmission unit 40, and makes a request to transmit the Delayed BA frame (Step S15).

The frame transmission unit 40 which receives the transmission request in Step S15 transmits the Delayed BA frame onto the wireless transmission path according to the wireless LAN protocol (Step S16). The frame transmission unit 40 performs the acknowledgement of the reception of the ACK frame corresponding to the transmitted Delayed BA frame. The acknowledgement of the reception can be performed based on whether or not the ACK frame is received in the frame reception unit 50 or the physical layer reception unit 21. In cases where the ACK frame cannot be received, the Delayed BA frame is transmitted again to perform the acknowledgement that the Delayed BA frame is positively transmitted.

The frame transmission unit 40 which has transmitted the Delayed BA frame and performs the acknowledgement of the reception of the ACK frame issues a notification that the transmission of the Delayed BA frame is completed to the Delayed BA transmission unit 62 (Step S17).

Thus, the processing is ended.

### <Effect>

The following effect (1) is obtained in the wireless communication system of the first embodiment.

(1) Data transmission efficiency can be improved in the wireless communication system (part 1).

In the configuration of the first embodiment, when the acknowledgement information is discarded in the wireless communication apparatus having the partial state BA function, the acknowledgement information is transmitted to the data source by the Delayed BA frame. Accordingly, the wasted re-transmission of the frame can be constrained to improve throughput of the wireless communication system. The effect (1) will be described in detail in comparison with the case in which the transmission is not performed by the Delayed BA frame.

For example, when the Delayed BA frame is not transmitted at time t5 in the example of FIG. 9, the wireless LAN terminal B transmits the BAR frame to make a request to transmit the BA frame to the wireless LAN base station 2 again.

However, at this point, because the wireless LAN base station 2 has already discarded therefore dose not retain the acknowledgement information on A-MPDU 1, the wireless LAN base station 2 sends back the BA frame of the information that MPDU 1 to MPDU 4 included in A-MPDU 1 are not received to the wireless LAN terminal B.

The wireless LAN terminal B which receives the BA frame then transmits A-MPDU 1 to the wireless LAN base station 2 again. However, because actually A-MPDU 1 is received at the time t1 by the wireless LAN base station 2, the re-transmission of A-MPDU1 is wasted. The wireless transmission path is occupied for a long time by the unnecessary data transmission, thereby deteriorating the data transmission efficiency in the wireless LAN system.

On the other hand, in the wireless communication system of the first embodiment, the problem can be solved to improve the data transmission efficiency. In the wireless communication apparatus with the partial state BA function, the number of data streams which can be managed by the BA management unit 51 is restricted. In the wireless LAN base station 2 of FIG. 2, n data streams can be managed. Therefore, in the partial state BA function, the bitmap information is overwritten when dealing with the number of data streams which exceeds the upper limit.

In the configuration of the first embodiment, when the overwrite of the bitmap information is happened, the bitmap information to be overwritten is temporarily saved, and is transmitted as the Delayed BA frame to the data source. The use of the Delayed BA frame can construct and transmit the BA frame using the temporarily saved bitmap information after the Immediate BA frame corresponding to the newly received data is transmitted. Accordingly, as described above with reference to FIG. 9, the acknowledgement information can positively be transmitted to the data source by the Delayed BA frame, and the wasted data re-transmission can be prevented. In the example of FIG. 9, the BA frame relating to A-MPDU 1 can be transmitted to the wireless LAN terminal B by the Delayed BA frame which is transmitted at the time t5. Accordingly, the need for the re-transmission of A-MPDU 1 is eliminated, so that the occupation of the wireless transmission path caused by the wasted data re-transmission can be prevented to improve the data transmission efficiency in the wireless LAN system.

In the example of FIG. 10, notification of the erasure of the bitmap information by the BA management unit 51 (Step S11) and acquisition of the actual bitmap information by the Delayed BA transmission unit 62 (Step S13) are separately performed in different steps. Alternatively, the Delayed BA transmission unit 62 may be notified of the bitmap information which becomes the erasure target simultaneously with the notification in Step S11. In such cases, the need for the processing in Step S12 is eliminated.

When the notification of the erasure of the bitmap information can be issued before the bitmap information is actually erased, the bitmap information which is of the erasure target is transmitted to the Delayed BA transmission unit 62 at that time, thereby eliminating the save region.

In the first embodiment, the wireless LAN base station 2 transmits the Delayed BA frame.

Alternatively, the wireless LAN terminal 3 may transmit the Delayed BA frame.

### Second Embodiment

A wireless communication apparatus according to a second embodiment of the present invention will be described below. In the second embodiment, instead of the BA management unit 51 of the first embodiment, the reordering management unit 61 provides the bitmap information which is of the erasure target. Because the configurations of the wireless LAN base station 2, wireless LAN terminal, and other operations are similar to those of the first embodiment, the description is omitted.

First, the reordering management unit 61 described in the first embodiment will be described in detail. As described above, in the data communication using the Block Ack function, it is not always necessary that the data frames be transmitted in the order of the sequence number SN. However, it is necessary that the data frames be transferred to the higher-level layer in the order of the sequence number SN. Therefore, the reordering management unit 61 performs the processing for reordering the received data to transfer the reordered data to the higher-level layer.

FIG. 11 is block diagrams showing the BA management unit 51 and the reordering management unit 61. As shown in FIG. 11, it is assumed that the wireless LAN base station 2 receives, for example, A-MPDU in which MPDU 1 to MPDU 3 are aggregated. At this point, it is assumed that the transmission is performed in the order of MPDU 3 (SN=3), MPDU 1 (SN=1), and MPDU 2 (SN=2). Therefore, the BA management unit 51 retains the bitmap information on A-MPDU. The reordering management unit 61 temporarily stores the packets of MPDU 1 to MPDU 3. The reordering management unit 61 then reorders the received MPDU 1 to MPDU 3, and supplies the packets in the order of MPDU 1 to MPDU 3 to the higher-level layer.

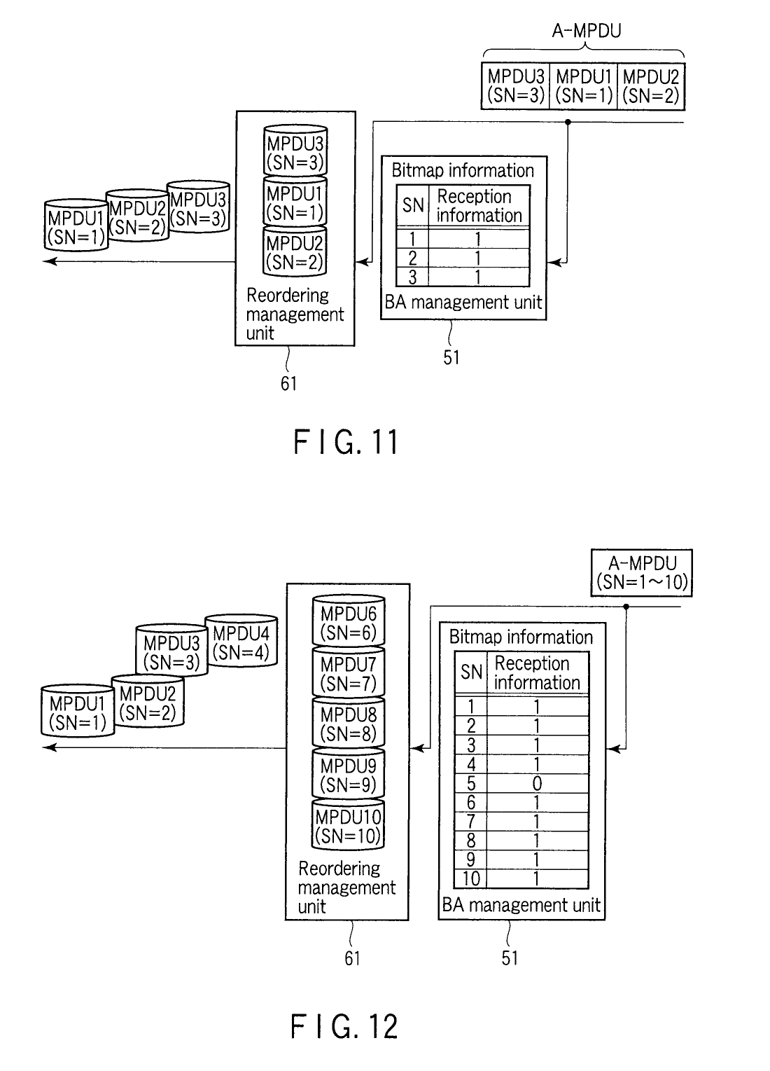

Thus, when the reordering management unit 61 fails to receive any of the frames of A-MPDU, in order to supply the packets in the order of the sequence number SN to the higher-level layer as described above, the reordering management unit 61 waits for the re-transmission of the frames, and supplies the frame having the sequence number SN from the failed framed to the higher-level layer. A specific example will be described with reference to FIG. 12.

FIG. 12 is, like in FIG. 11, a block diagram showing the BA management unit 51 and the reordering management unit 61. As shown in FIG. 12, it is assumed that wireless LAN base station 2 receives A-MPDU in which MPDU 1 to MPDU 10 are aggregated. The BA management unit 51 retains the bitmap information on A-MPDU. At this point, it is assumed that only MPDU 5 (SN=5) cannot be received. The reordering management unit 61 then tentatively stores the packets of MPDU 1 to MPDU 4 and MPDU 6 to MPDU 10 except for MPDU 5, and supplies the packets of MPDU 1 to MPDU 4 in the order of the sequence number SN to the higher-level layer. The reordering management unit 61 supplies the rest of the packets from MPDU 6 to the higher-level layer after receiving MPDU 5.

Accordingly, the reordering management unit 61 does not retain the bitmap information, but the data actually received, so that the reordering management unit 61 can produce the bitmap information based on the retained data.

Therefore, in the second embodiment, instead of the BA management unit 51 of the first embodiment, the reordering management unit 61 provides the bitmap information to the frame transmission unit 40. Accordingly, the data transmission and reception sequences in the wireless communication system 1 of the second embodiment are similar to those of the first embodiment shown in FIG. 9.

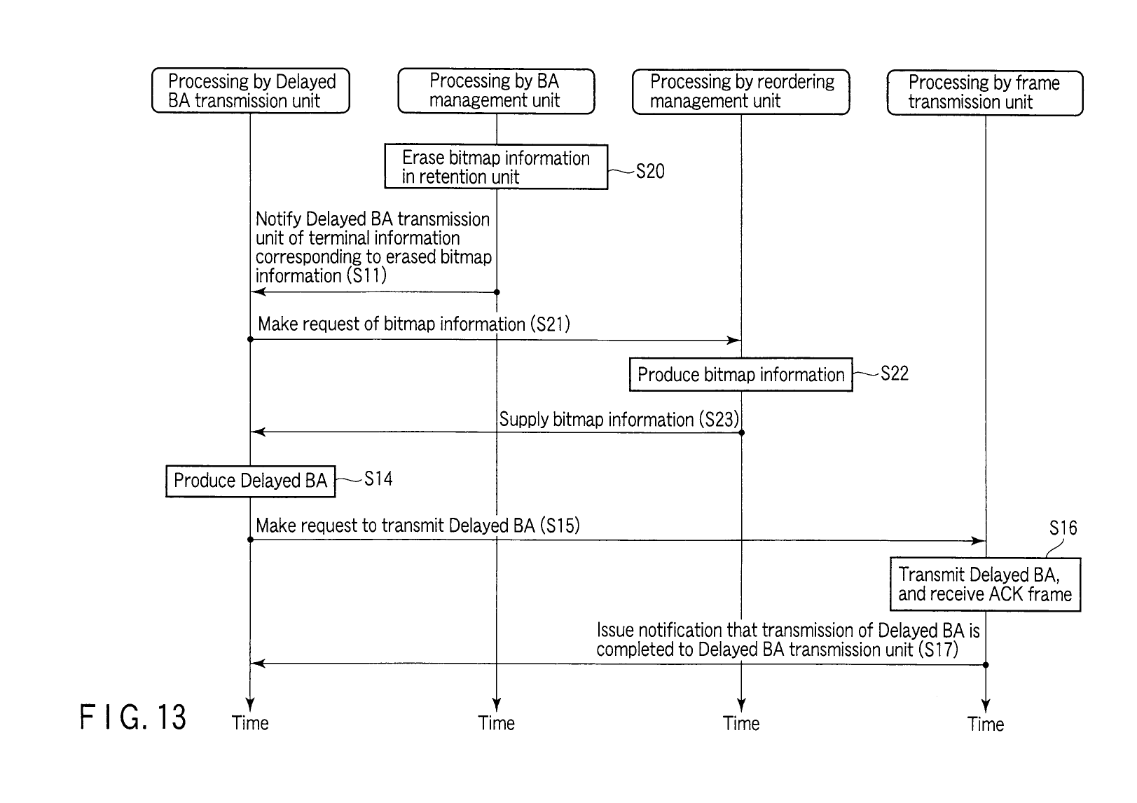

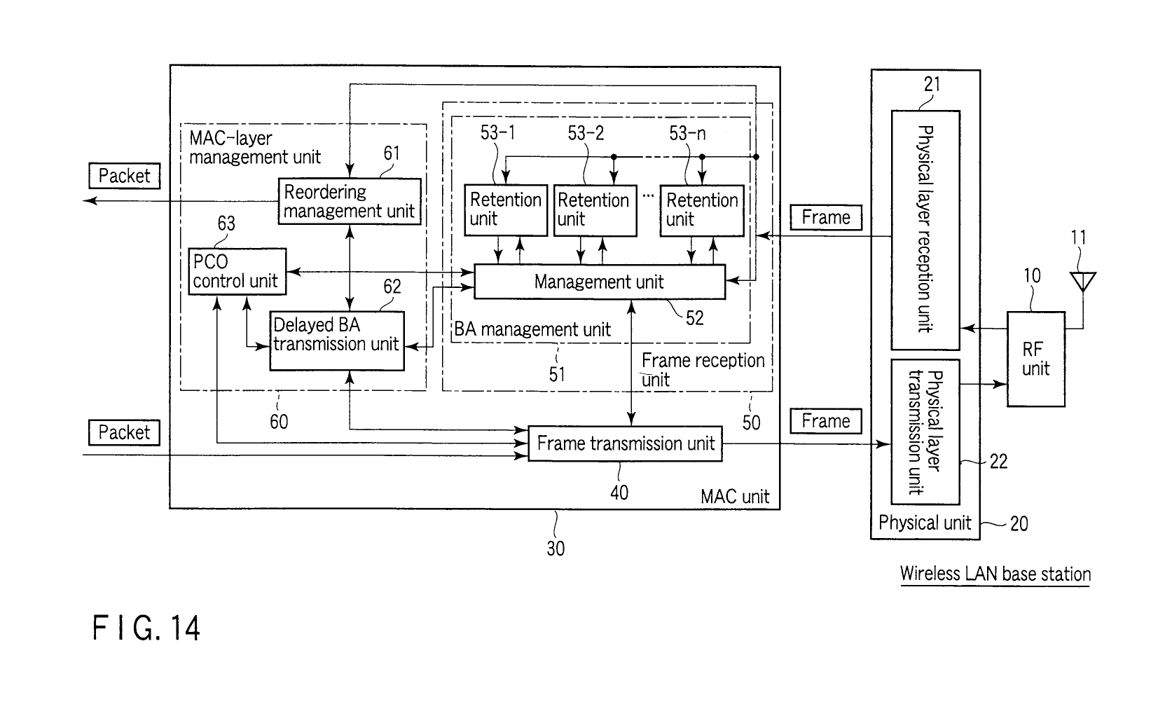

An operation of the wireless LAN base station 2 of the second embodiment will now be described in detail with reference to FIG. 13. FIG. 13 is a flowchart showing the operation of the wireless communication apparatus 2 of the second embodiment, particularly showing the processing performed by the frame transmission unit 40, the BA management unit 51, the reordering management unit 61, and the Delayed BA transmission unit 62.

Referring to FIG. 13, the BA management unit 51 detects an event in which the acknowledgement information is erased, and the management unit 52 erases the acknowledgement information in the retention unit 53 (Step S20). The acknowledgement information which is erased is the information on A-MPDU 1 in FIG. 9. The management unit 52 performs the processing in Step S11 described in the first embodiment.

The Delayed BA transmission unit 62 which is notified of the erasure of the acknowledgement information makes a request of the bitmap information corresponding to the wireless LAN terminal B whose acknowledgement information is erased to the reordering management unit 61 (Step S21).

The reordering management unit 61 produces the bitmap information in response to the request in Step S21 (Step S22). In the example of FIG. 9, the reordering management unit 61 produces the bitmap information on A-MPDU 1 based on the data of A-MPDU 1 retained by the reordering management unit 61 itself, and supplies the produced bitmap information to the Delayed BA transmission unit 62 (Step S23).

Then the processing in Steps S14 to S17 described in the first embodiment is performed.

In this embodiment, the wireless LAN base station 2 transmits the Delayed BA frame, however, similarly to the first embodiment, the wireless LAN terminal 3 may transmit the Delayed BA frame.

### <Effect>

The following effects (2) and (3) are obtained in the wireless communication system of the second embodiment.

(2) The data transmission efficiency can be improved in the wireless communication system (part 2).

In the configuration of the second embodiment, the reordering management unit 61 produces the bitmap information. The Delayed BA frame is transmitted using the bitmap information produced by the reordering management unit 61. The effect similar to the effect (1) of the first embodiment is obtained by the method of the second embodiment.

Generally, in implementing the MAC unit 30, the frame transmission unit 40 and the frame reception unit 50 are implemented by hardware, while the MAC-layer management unit 60 is frequently implemented by software. Because a quick response and a quick operation are required in transmitting and receiving the frame, preferably the frame transmission unit 40 and the frame reception unit 50 are implemented using a digital circuit such as LSI. On the other hand, for the MAC-layer management unit 60, because immediacy is less required in the management processing such as the protocol processing while the management processing is complicated, generally the MAC-layer management unit 60 is implemented as a software program running on CPU.

Therefore, due to a difference in implementing method between the hardware and the software mounting, it is possible that the interface is not provided between the management unit 52 and the Delayed BA transmission unit 62 unlike the one described in the first embodiment.

The reordering management unit 61 can learn the sequence number SN and transmission source of received frame, although the reordering management unit 61 does not retain the bitmap information. Therefore, the reordering management unit 61 which is also implemented by software produces the bitmap information, so that the bitmap information can be supplied to the Delayed BA transmission unit 62.

(3) The wireless communication apparatus can be miniaturized.

In the configuration of the second embodiment, because the reordering management unit 61 produces the bitmap information, it is not necessary that the bitmap information which should be erased in the retention unit 53 be saved in the save region. Accordingly, the save region can be eliminated to miniaturize the wireless communication apparatus.

### Third Embodiment

A wireless communication apparatus according to a third embodiment of the present invention will be described below. In the third embodiment, the Delayed BA frame is transmitted in making a prediction that the bitmap information in the retention unit 53 is erased in the first embodiment. FIG. 14 is a block diagram showing a wireless LAN base station 2 of the third embodiment.

As shown in FIG. 14, in the wireless LAN base station 2 of the third embodiment, the MAC-layer management unit 60 includes a PCO management unit 63 in addition to the configuration of the first embodiment referring to FIG. 2. Other configurations are similar to those of FIG. 2. Only a point which is different from that of the first embodiment will be described below.

A main role of the PCO control unit 63 is to control a Phased Coexistence Operation (PCO) function. The PCO function is an optional function which is newly added as the MAC function in IEEE 802.11n. The PCO control unit 63 produces the beacon frame and the Set PCO phase frame, and supplies those frames through the frame transmission unit 40.

The PCO function will be described before the operation of the wireless LAN base station 2 of the third embodiment is described.

### <PCO Function>

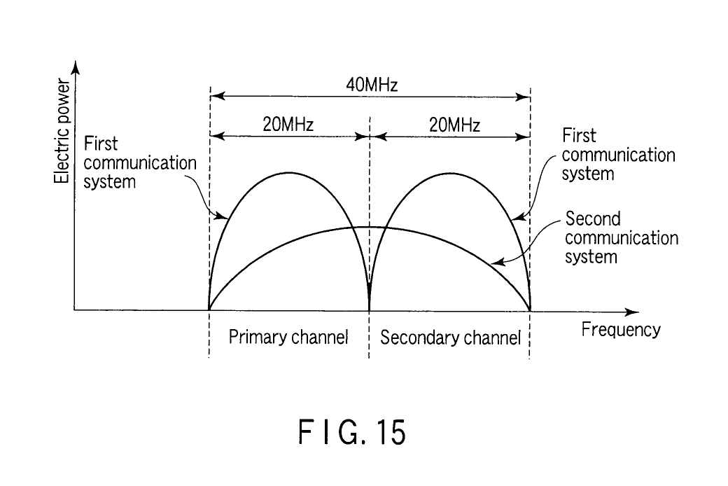

FIG. 15 is a band diagram showing a frequency band used in the wireless LAN base stations 3 pursuant to the IEEE 802.11n standard.

In the conventional wireless LAN system, the communication (first communication system) is conducted in a 20-MHz band while the 20-MHz band is used as one channel. In addition, 40-MHz-band communication (second communication system) in which an adjacent 20-MHz band is simultaneously used is permitted in the IEEE 802.11n standard. However, in consideration of backward compatibility with the already-existing wireless LAN terminal, the 20-MHz-band communication and the 40-MHz-band communication are used in combination. A channel which accommodates the wireless LAN terminal conducting only the 20-MHz-band communication is referred to as primary channel, and a channel which is used only for the band spreading during the 40-MHz-band communication is referred to as secondary channel. Although the primary channel is located on the low-frequency side of the secondary channel in FIG. 15, the primary channel may be located on the high-frequency side of the secondary channel.

Because the wireless LAN terminal which communicates using only the 20-MHz-band cannot receive the frame transmitted in the 40-MHz-band, a problem is occurred in mutual connection. Therefore, a system for coexistence of the wireless LAN terminal which communicates using the 40-MHz-band and the wireless LAN terminal which communicates using only the 20-MHz-band is also included in the IEEE 802.11n standard, and one of the systems is the PCO function.

In the PCO function, the wireless LAN base station which utilizes the PCO function leads settings of a 20-MHz-band communication period (first communication period) and a 40-MHz-band communication period (second communication period). The wireless LAN base station uses the management frame to notify all the wireless LAN terminals accommodated in the wireless LAN base station of an instruction of transition of each period. Therefore, in the second communication period, the wireless LAN terminal which conducts the communication only by the first communication system, that is, the wireless LAN terminal which does not have the PCO function is prohibited to conduct the communication, and the problem with the mutual connection can be prevented.

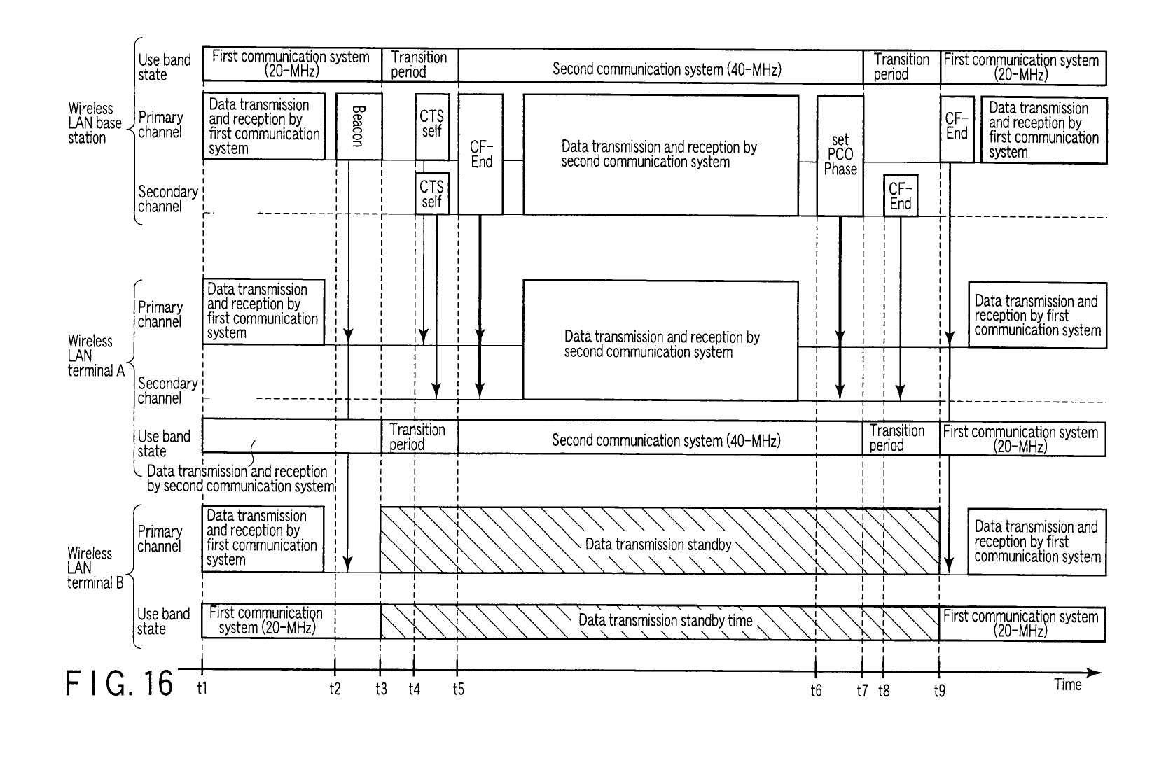

FIG. 16 is a timing chart showing a frame exchange sequence when the wireless communication systems are switched using the PCO function. Hereinafter the wireless LAN terminal 3 which can conduct communication in both the 20-MHz-band and the 40-MHz-band is referred to as wireless LAN terminal A, and the wireless LAN terminal 3 which can conduct communication only in the 20-MHz band is referred to as wireless LAN terminal B.

Referring to FIG. 16, the wireless communication is conducted in the 20-MHz-band at time t1. The wireless LAN base station 2 issues a command for making a transition from the first communication system (20-MHz-band communication) to the second communication system (40-MHz-band communication) to the wireless LAN terminal 3 at time t2. That is, the PCO control unit 63 in the MAC-layer management unit 60 produces the beacon frame or Set PCO phase frame whose destination is set at a broadcast address. The beacon frame or Set PCO phase frame includes the command for making the transition from the first communication system to the second communication system. The beacon frame or Set PCO phase frame is transmitted to all the wireless LAN terminals 3 accommodated in the wireless LAN base station 2, thereby performing the command for making the transition to the second communication system.

At this point, the PCO control unit 63 sets a period until the second communication system is returned to the first communication period since the transition to the second communication system is made at a Duration field of the beacon frame or Set PCO phase frame. Therefore, a communication standby period called a Network Allocation Vector (NAV) is set at all the wireless LAN terminals 3, and all the wireless LAN terminals 3 become a communication standby (data transmission standby) state. In the data transmission standby state, although the wireless LAN terminal 3 can receive the frame transmitted from the wireless LAN base station 2, but is prohibited to transmit the data frame to the wireless LAN base station 2 by itself. However, the wireless LAN terminal 3 is permitted to transmit the response frame such as the ACK frame and the BA frame.

Then the wireless LAN base station 2 and wireless LAN terminal A in which the PCO function is used make the transition to the second communication system (40-MHz-band communication) in a transition period (times t3 to t5) which is previously set by the wireless LAN base station 2.

In addition, the wireless LAN base station 2 sets NAV at the secondary channel in the transition period. That is, the PCO control unit 63 transmits a CTS-self frame to the secondary channel side in order to set other wireless LAN terminals, which exist in the secondary channel and are not accommodated in the wireless LAN base station 2, at the communication standby (data transmission standby) state. A period (second communication period) until the second communication system is returned to the first communication system is set at the Duration field of the CTS-self frame. Although the CTS-self frame can be transmitted to both the primary channel and the secondary channel, the CTS-self frame is enough to be transmitted to the secondary channel only because the CTS-self frame is used for the above-described purpose.

After the transition period, the PCO control unit 63 of the wireless LAN base station 2 transmits the CF-End frame at time t5 by the second communication system. The CF-End frame can clear the communication standby (data transmission standby) state set by NAV. Only the wireless LAN terminal 3, in which the PCO function is used and transition to the second communication system is made, can correctly receive the CF-End frame when the CF-End frame is transmitted by the second communication system. Therefore, only wireless LAN terminal A which makes the transition to the second communication system can conduct communication.

Then, in the communication period of the second communication system, only the wireless LAN base station 2 and the wireless LAN terminal A transmit and receive the data using the 40-MHz-band.

After the second communication period elapses, the wireless LAN base station 2 issues a command for returning to the first communication system from the second communication system to wireless LAN terminal A. That is, the PCO control unit 63 of the wireless LAN base station 2 transmits the Set PCO phase frame as the broadcast frame by the second communication system (time t6). Therefore, wireless LAN terminal A makes the transition from the second communication system to the first communication system.

At this point, similarly to the case in which the transition to the second communication system is made, the wireless LAN base station 2 provides a transition period (times t7 to t9). In the transition period, the wireless LAN base station 2 transmits the CF-End frame in the secondary channel. Therefore, NAV set by the CTS-self frame in making the transition to the second communication system is cleared to end the communication standby state.

The wireless LAN base station 2 also transmits the CF-End frame through the primary channel at time t9 that the transition period is ended. Therefore, the wireless LAN base station 2 clears NAV of wireless LAN terminal B accommodated in the wireless LAN base station 2 and using no the PCO function to end the communication standby state.

As a result, all the wireless LAN terminals 3 accommodated in the wireless LAN base station 2 can resume the communication by the first communication system.

Through the series of frame exchanges, the wireless LAN base station 2 can arbitrarily set the first communication period and the second communication period. The wireless LAN terminal A which has the PCO function to be able to conduct communication by the second communication system can exist with the already-existing wireless LAN terminal B or the wireless LAN terminal B which can use only the first communication system although conforming to the IEEE 802.11n standard.

### <Operation of Wireless LAN Base Station 2>

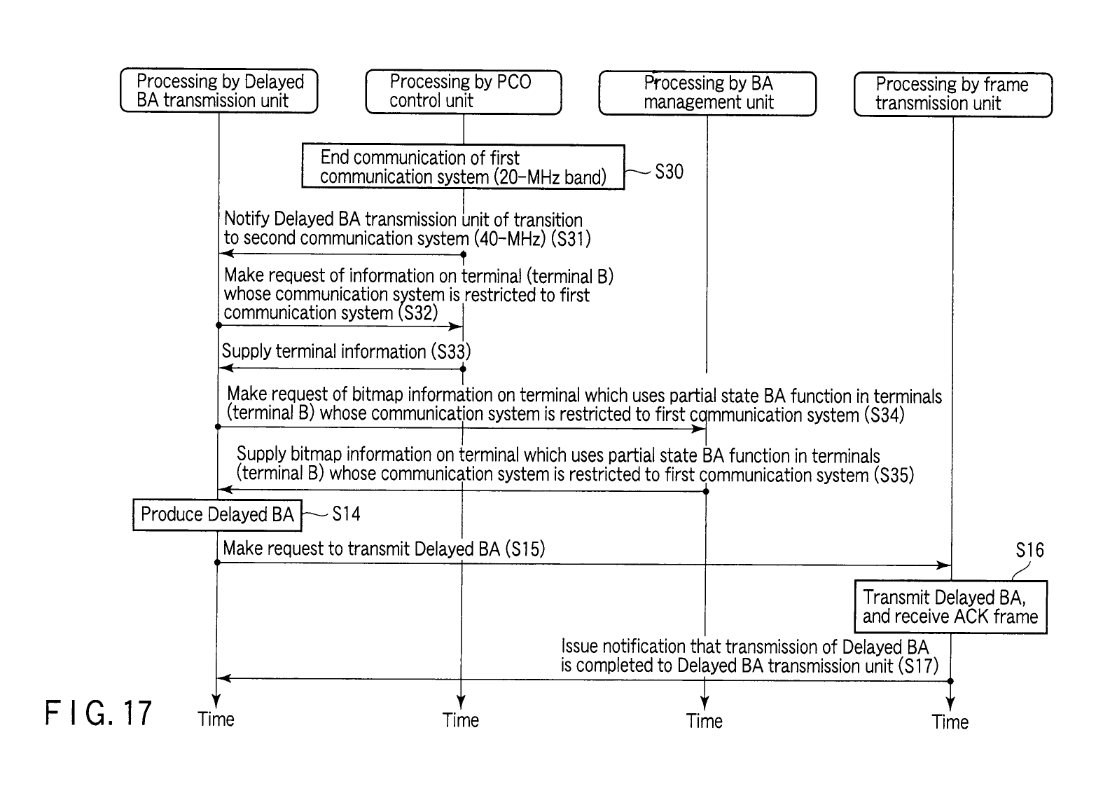

The wireless LAN base station 2 having the PCO function determines that the transition from the first communication system to the second communication system is the case in which the prediction that the bitmap information is erased in the retention unit 53 is made. At this point, the wireless LAN base station 2 transmits the bitmap information retained in the retention unit 53 as the Delayed BA frame. Hereinafter an operation of the wireless LAN base station 2 in transmitting the Delayed BA frame will be described with reference to FIG. 17. FIG. 17 is a flowchart showing the operation of the wireless LAN base station 2, particularly showing the processing performed by the frame transmission unit 40, the BA management unit 51, the PCO control unit 63, and the Delayed BA transmission unit 62.

First the PCO control unit 63 ends the communication of the first communication system (20-MHz-band communication) (Step S30). This corresponds to time t3 of FIG. 16. The PCO control unit 63 notifies the Delayed BA transmission unit 62 that the communication system is changed from the first communication system to the second communication system (40-MHz-band communication) (Step S31). The PCO control unit 63 then sets the transition period.

The Delayed BA transmission unit 62 which receives the change notification in Step S31 makes a request of terminal information on the wireless LAN terminal B to the PCO control unit 63 in order to transmit the Delayed BA frame to the wireless LAN terminal B (Step S32).

In response to the request in Step S32, the PCO control unit 63 transmits information on the wireless LAN terminal 3 which does not have the PCO function in the wireless LAN terminals 3 managed by the PCO control unit 63, that is, the wireless LAN terminal B to the Delayed BA transmission unit 62 (Step S33).

The Delayed BA transmission unit 62 which receives the information on the wireless LAN terminal B in Step S33 makes a request of the bitmap information on the wireless LAN terminal B which conducts communication using the partial state BA function to the management unit 52 in the BA management unit 51 (Step S34).

In response to the request in Step S34 the management unit 52 in the BA management unit 51 sends back the bitmap information retained in one of the retention units 53 to the Delayed BA transmission unit 62 (Step S35).

Then the processing in Steps S14 to S17 of the first embodiment is performed. The processing in Steps S14 to S17 is performed to all the wireless LAN terminals B in which the transmission of the Delayed BA frame is required. Thus, the processing is ended.

The processing in Steps S30 to S17 is performed in the transition period. Accordingly, in cases where the number of wireless LAN terminals B to which the Delayed BA frame should be transmitted is large, the transition period may be set longer than usual. That is, the transition period may be set according to the number of wireless LAN terminals B to which the bitmap information should be transmitted.

### <Effect>

The following effect (4) is obtained in the wireless communication system of the third embodiment.

(4) The data transmission efficiency can be improved in the wireless communication system (part 3).

As described above, in the IEEE 802.11n standard, the wireless LAN terminal A which can conduct communication in the 20-MHz-band and the 40-MHz-band and the wireless LAN terminal B which can conduct communication only in the 20-MHz-band can be accommodated in the wireless LAN base station by supporting the PCO function.

However, in the PCO function, NAV is set at the wireless LAN terminal B between the 40-MHz-band communication period and the transition period, and the wireless LAN terminal B forcedly makes the transition to the communication standby state. Therefore, when the wireless LAN terminal B which is pursuant to the IEEE 802.11n standard uses the partial state BA function to conduct Block Ack communication, the following problem is generated.

It is assumed that the wireless LAN terminal B already transmits the data while not transmitting the BA frame yet. At this point, when the transition from the 20-MHz-band communication to the 40-MHz-band communication is made, the 40-MHz-band communication is started while the acknowledgement information on the wireless LAN terminal B is retained in the retention unit 53 of the wireless LAN base station 2. When the 40-MHz-band communication is started, the wireless LAN terminal A is only the other party of the wireless LAN base station 2. Accordingly, the acknowledgement information on the wireless LAN terminal B is highly likely overwritten by the acknowledgement information on the wireless LAN terminal A in which the 40-MHz-band communication is started.

In the third embodiment, the bitmap information on the wireless LAN terminal B which is already retained in the retention unit 53 is transmitted to the wireless LAN terminal B using the Delayed BA frame during the transition from the 20-MHz-band communication to the 40-MHz-band communication. Accordingly, similarly to the effect (1) of the first embodiment, the wasted re-transmission which is highly likely occurred after that can be prevented to improve the data transmission efficiency in the wireless communication system.

Sometimes the Delayed BA transmission unit 62 obtains the terminal information on the plural terminals from the PCO control unit 63. In such case, the information on the plural terminals may collectively be notified, or the information on each terminal may separately be notified several times.

In case where the plural terminals B with the partial state BA function, the bitmap information on the plural terminals B is collectively be requested and obtained, or the information on each terminal B may separately be requested and obtained. At this point, it is necessary to transmit the plural Delayed BA frames related to each terminal B. Therefore, the Delayed BA frame transmission requests to the frame transmission unit 40 may simultaneously be made for the plural terminals, or the requests may separately be made for the plural terminals.

The notification of the transition (Step S31) may not always performed at the time the 20-MHz-band communication is ended, but before the communication is ended with a temporal margin of the Delayed BA frame transmission.

Further, as described in the first embodiment, the processing in Step S33 of FIG. 17 may be performed along with the processing in Step S31. In such cases, the processing in Step S32 is eliminated.

### Fourth Embodiment

A wireless communication apparatus according to a fourth embodiment of the invention will be described below. In the fourth embodiment, instead of the BA management unit 51, the reordering management unit 61 provides the bitmap information which becomes the erasure target, similar to the second embodiment. Because a configuration of the wireless LAN base station 2 is similar to that of the third embodiment, the description is omitted. The operation of the reordering management unit 61 is similar to that of the second embodiment. Accordingly, only a point which is different from those of the second and third embodiments will be described.

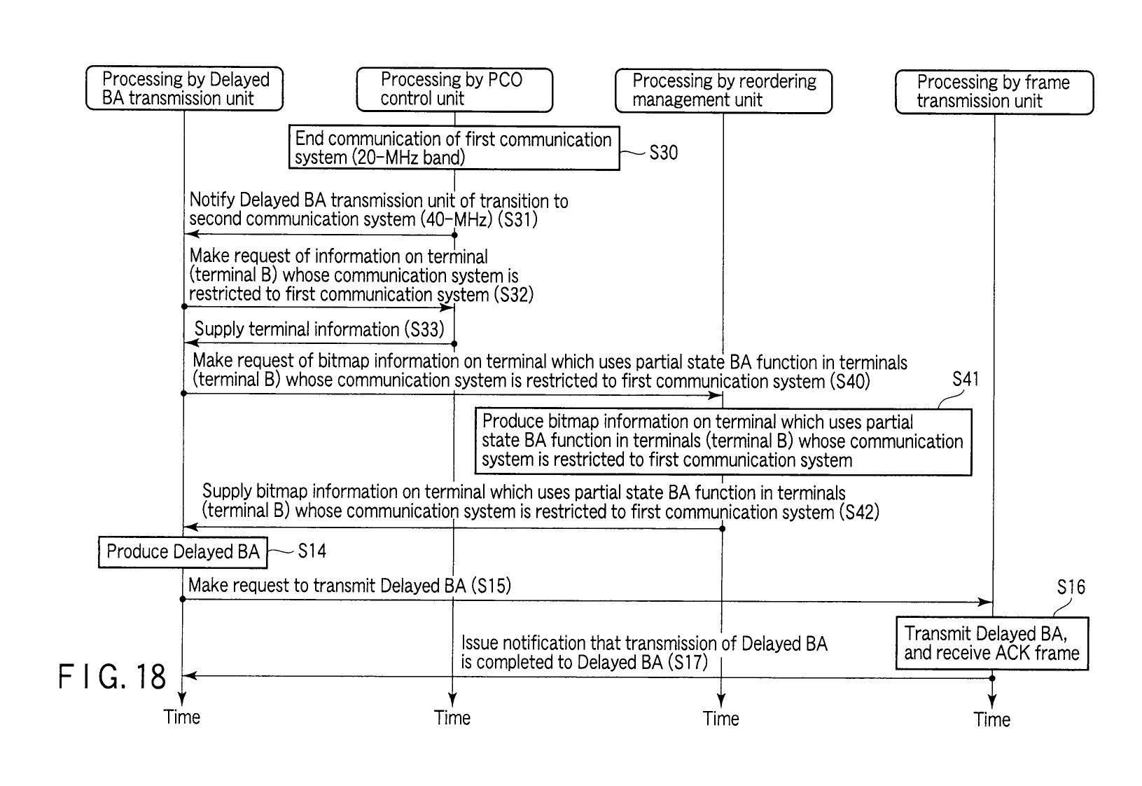

FIG. 18 is a flowchart showing an operation of the wireless LAN base station 2 of the fourth embodiment, particularly showing the processing performed by the frame transmission unit 40, the BA management unit 51, the reordering management unit 61, and the Delayed BA transmission unit 62.

First the processing in Steps S30 to S33 of the third embodiment is performed. Then the Delayed BA transmission unit 62 makes a request of the bitmap information on the wireless LAN terminal B which conducts communication using the partial state BA function to the reordering management unit 61 (Step S40).

In response to the request in Step S40, the reordering management unit 61 produces the bitmap information (Step S41), and supplies the produced bitmap information to the Delayed BA transmission unit 62 (Step S42).

Then the processing in Steps S14 to S17 of the first embodiment is performed.

The effect (4) of the third embodiment is also obtained in the wireless communication system of the fourth embodiment.

Thus, the wireless communication apparatus of the first to fourth embodiments are capable of receiving the data which includes the plural data frames transmitted from the same data source and managed by the same traffic identifier, and the apparatus perform the acknowledgement (block acknowledgement) to the data source in response to the reception of the data.

The wireless communication apparatus includes the acknowledgement information management unit (BA management unit 51) which retains the acknowledgement information used to perform the acknowledgement in each data and the transmission unit (Delayed BA transmission unit 62) which performs the acknowledgement to the data source using the acknowledgement information.

When data is newly received from a different data source, or when data managed by a different traffic identifier is newly received from the same data source, the acknowledgement information management unit 51 discards the already-retaining acknowledgement information in order to retain the acknowledgement information on the data.

When the acknowledgement information management unit 51 discards the acknowledgement information, or when the prediction on the discard is made, the transmission unit 62 performs the acknowledgement (Delayed BA) using the acknowledgement information which is discarded or the acknowledgement information in which the prediction on the discard is made irrespective of the request of the acknowledgement from the data source.

The wireless communication apparatus are capable of communicating with plural wireless communication terminals using the first wireless communication system (20-MHz-band communication) and second wireless communication system (40-MHz-band communication) which differ from each other in the use frequency band width. The case, in which the communication system makes the transition from the first wireless communication system to the second wireless communication system while one of the wireless communication terminals communicates only by the first wireless communication system, can be cited as an example of the prediction that the acknowledgement information is discarded.

Thus, the wasted re-transmission caused by the discard the acknowledgement information before transmitting the BA frame can be prevented to improve the data transmission efficiency.

The case, in which the prediction on the discard of the acknowledgement information is made, is not limited to the case in which the communication system makes the transition. The first and third embodiments may be combined, and the second and fourth embodiments may be combined. Therefore, the data transmission efficiency is further improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication apparatus comprising:
a reception unit which is capable of receiving data including a plurality of data frames, the data frames being transmitted from an identical data source and managed by an identical traffic identifier;
an information management unit which retains acknowledgement information to perform an acknowledgement in the each data received by the reception unit, the information management unit discarding an already-retaining acknowledgement information in order to retain acknowledgement information on data when the data is newly received from a data source different from a data source corresponding to the already-retaining acknowledgement information or when the data whose traffic identifier is different from a traffic identifier of the already-retaining acknowledgement information is newly received from the data source identical to the data source corresponding to the already-retaining acknowledgement information; and
a transmission unit which performs the acknowledgement to the data source of the data using the acknowledgement information, the transmission unit performing the acknowledgement to the data corresponding to the acknowledgement information irrespective of a request of the acknowledgement from the data source when the information management unit discards the acknowledgement information or when a prediction on the discard of the acknowledgement information is made.

2. The apparatus according to claim 1, wherein the information management unit includes:
at least one retention unit which retains the acknowledgement information in the each data; and
a management unit which discards the acknowledgement information retained in one retention unit when the reception unit newly receives the data while no retention unit has a free area to retain the acknowledgement information.

3. The apparatus according to claim 2, wherein the transmission unit performs the acknowledgement using the acknowledgement information retained in the retention unit.

4. The apparatus according to claim 3, wherein, when the reception unit newly receives the data while no retention unit has the free area,
the management unit causes the one retention unit which is emptied by discarding the retained acknowledgement information to retain acknowledgement information on the newly-received data, and
the management unit supplies the acknowledgement information which becomes a discard target to the transmission unit.

5. The apparatus according to claim 1, wherein the apparatus is capable of communicating with a plurality of wireless communication terminals using a first wireless communication system and a second wireless communication system, the first wireless communication system and the second wireless communication system differing from each other in a use frequency band width, and
the case in which the prediction on the discard of the acknowledgement information is made is a case in which a communication system makes a transition from the first wireless communication system to the second wireless communication system while one of the wireless communication terminals communicates only by the first wireless communication system.

6. The apparatus according to claim 5, wherein the frequency band widths used in the first wireless communication system and the second wireless communication system are 20 MHz and 40 MHz, respectively.

7. The apparatus according to claim 1, further comprising a reordering management unit which supplies the data frames included in the received data in the order of a sequence number to a processing unit which processes the data.

8. The apparatus according to claim 7, wherein the reordering management unit produces the acknowledgement information, and
the transmission unit performs the acknowledgement using the acknowledgement information produced by the reordering management unit.

9. The apparatus according to claim 1, wherein the acknowledgement information includes bitmap information.

10. The apparatus according to claim 1, wherein the transmission unit performs the acknowledgement using a Delayed BA frame.

11. A wireless communication method comprising:
receiving data including a plurality of data frames, the data frames being transmitted from an identical data source and managed by an identical traffic identifier;
discarding already-retaining acknowledgement information in order to retain acknowledgement information on the received data; and
transmitting a frame for acknowledgement using a Delayed BA frame with respect to the data corresponding to the acknowledgement information which becomes a discard target irrespective of a request of the acknowledgement from a data source.

12. The method according to claim 11, further comprising saving the acknowledgement information before discarding the acknowledgement information,
wherein the frame for the acknowledgement is produced using saved acknowledgement information.

13. The method according to claim 11, further comprising:
retaining tentatively the data after receiving the data and supplying the data frames in the order of a sequence number; and
producing acknowledgement information on the data based on the result of the tentative retention of the data,
wherein the frame for the acknowledgement is produced using the acknowledgement information produced based on the result of the tentative retention of the data.

14. A wireless communication method comprising:
making a request of acknowledgement information on already-received data when a prediction the discard of the acknowledgement information on the data is made, the data including a plurality of data frames, the plurality of data frames being transmitted from an identical data source and managed by an identical traffic identifier; and
transmitting a frame for acknowledgement by a Delayed BA frame using the acknowledgement information.

15. The method according to claim 14, wherein the case in which the prediction on the discard of the acknowledgement information is made is a case in which a communication system makes a transition from a first wireless communication system to a second wireless communication system while a wireless communication terminal which is the other party of a wireless communication communicates only by the first wireless communication system, the first wireless communication system and the second wireless communication system differing from each other in a use frequency band width.

16. The method according to claim 15, wherein the frequency band widths used in the first wireless communication system and the second wireless communication system are 20 MHz and 40 MHz, respectively.

17. The method according to claim 14, further comprising:
retaining tentatively the received data to supply the data frames in the order of a sequence number; and
producing acknowledgement information on the data based on the result of the tentative retention of the data,
wherein the frame for the acknowledgement is produced using the acknowledgement information produced based on the result of the tentative retention of the data.
